(19) United States
(12) Patent Application Publication
(10) Pub. No.: US 2006/0092264 A1
(43) Pub. Date: May 4, 2006

(54) Image forming apparatus and image forming method

(75) Inventors: Yoshiki Matsuzaki, Kanagawa (JP); Kozo Tagawa, Kanagawa (JP); Takeshi Kato, Kanagawa (JP); Osamu Goto, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/085,174

(22) Filed: Mar. 22, 2005

(30) Foreign Application Priority Data
Oct. 29, 2004 (JP) P.2004-315682

(51) Int. Cl. B41J 2/455

(52) U.S. Cl. 347/233

(57) ABSTRACT

An image forming apparatus having a plurality of light sources and printing an image carrier by collectively scanning an image carrier with beams from the plurality of light sources includes a screen processing unit for performing a screen process on input image data and a registration correction processing unit for performing skew correction on the image data on which the screen process has been performed and for performing an image shift process in the sub-scanning direction, which is a moving direction of the image carrier, based on a periodic characteristic of exposure by the collective scanning and the period of the screen by the screen process.

### BACKGROUND OF THE INVENTION

1. Field of the Invention

The present invention relates to an image forming apparatus, such as a printer or a duplicating machine, and particularly, to an image forming apparatus capable of printing a color image or a black-and-white image.

2. Background Art

In recent years, image forming apparatuses capable of forming a color image, such as a printer and a duplicating machine, have been widely spread. As this type of general image forming apparatus, there has been used a so-called tandem-type image forming apparatus in which image forming units respectively provided correspondingly to, for example, black (K), yellow (Y), magenta (M), and cyan (C) are arranged in parallel to a transfer object (a transfer belt, serving as an intermediate transfer member, and a sheet of paper, which is a recording medium). In this tandem-type image forming apparatus, images, having different colors, formed by the respective image forming units are sequentially transferred to a running transfer object and are then multiplexed, thereby forming a color image.

In this tandem-type image forming apparatus, the images having different colors overlap each other to form a color image. Therefore, color misalignment may occur in the formed image by deviation of mounting position of each image forming unit, an error in the peripheral velocity of each image forming unit, deviation of exposure position with respect to a transfer object, variation of the linear velocity of the transfer object, etc. That is, the alignment and mechanical errors of the image forming units provided correspondingly to each color leads to color misalignment on a recording medium (for example, a sheet) as they are. Further, in this type of image forming apparatus, it is indispensable to measure the amount of the color misalignment and to perform color misalignment control (registration control) to prevent the color misalignment. As a general method of controlling the color misalignment, there is a method of drawing yellow, magenta, cyan and black marks (patterns) on a transfer target, of reading the positions of the marks using a sensor, of calculating the amount of color misalignment from a result read, and of feeding it back to control the image forming units. Further, in addition to the tandem-type image forming apparatus, for example, a cycle-type image forming apparatus of forming a color image by rotating an image carrier plural times and a so-called inkjet-type image forming apparatus also have the same problems as described above.

As a conventional technique disclosed in patent documents, there has been disclosed a technique in which registration marks are formed at two different places on a transfer belt in the main scanning direction, the amount of color misalignment between a reference color and the other colors is calculated, an approximate function for correction is calculated based on the amount of the color misalignment, and an address of an image is changed to perform skew correction (for example, see JP-A-2000-112206). Further, there also has been disclosed another technique of correcting skew generated in printer head in a line unit by changing a writing address of an image and outputting it with a step difference (for example, see JP-A-2001-80124).

Furthermore, in recent years, there has been proposed an image forming apparatus using a so-called multi-beam scanning optical system of collectively irradiating a plurality of laser beams from a plurality of light sources by a rotary polygon mirror. Moreover, there has been proposed a technique in which, in an image forming apparatus using a multi-beam scanning optical system, sub-scanning misalignment is corrected by selecting one light source for performing recording on a first line from a plurality of light sources according to a difference in time between an image recording start signal and a laser operation synchronizing signal (for example, see JP-A-8-142412).

FIGS. 13A and 13B are views illustrating an example of a conventional process of correcting the misalignment of the sub-scanning direction in the image forming apparatus using the multi-beam scanning optical system (multi-beam raster output scanner (ROS)). In FIGS. 13A and 13B, the horizontal direction indicates a main scanning direction (A to R), and the vertical direction indicates a sub-scanning direction (1 to 24). In addition, scanning is performed using four multi-beams. As shown in FIG. 13B, the output position is changed in order to correct the misalignment of the sub-scanning direction, and the change is performed by shifting a laser used for forming an image by the multi-beams.

Further, FIGS. 14A and 14B are views illustrating a conventional process of performing skew correction in the image forming apparatus using the multi-beam scanning optical system. Similarly in FIGS. 13A and 13B, in FIGS. 14A and 14B, the horizontal direction indicates the main scanning direction, and the vertical direction indicates the sub-scanning direction. In addition, scanning is performed using four multi-beams. In FIG. 14B, output image data is stepwise shifted in the main scanning direction with respect to FIG. 14A. In this way, it is possible to make skew distortion smaller than that in a general line. For example, it is possible to perform good skew correction on colors drawn to be inclined with respect to the reference color.

Furthermore, FIGS. 15A to 15F illustrating the shift of a half-tone image in correcting the misalignment of the sub-scanning direction in the image forming apparatus using the multi-beam scanning optical system. The multi-beam ROS shown in this example is composed of four beams (LD1 to LD4) as shown in FIG. 15F, and in order to output an image having a width corresponding to 16 lines in the sub-scanning direction as shown in FIG. 15A, it is necessary to perform scanning four times as shown on the left side of FIG. 15A. FIGS. 15A to 15E illustrate the shift of a predetermined half-tone image (a check composed of a white-and-black binary image in a matrix of four by four dots) in the sub-scanning direction. In the image shown in FIG. 15A, writing starts using the laser LD1 shown in FIG. 15F, and in the image shown in FIG. 15B, writing starts using the laser LD2. Further, in the image shown in FIG. 15C, writing starts using the laser LD3 shown in FIG. 15F, and in the image shown in FIG. 15D, writing starts using the laser LD4. Furthermore, in FIG. 15E, writing is not performed by first scanning, but performed using the laser LD1 at the second scanning timing. In the example shown in FIGS. 15A to 15F, the gaps between the four beams shown in FIG. 15F are equal to each other, so that a half-tone image is not disarranged on a sheet as shown on the lower side of each of FIGS. 15A to 15E. That is, even when the skew correction or the correction of misalignment in the sub-scanning direction is performed, a substantially ideal image is obtained.

However, when misalignment occurs in the gap between the beams in the multi-beam scanning optical system, a preferred image is not obtained.

FIGS. 16A to 16F illustrate an example of the shift of a half-tone image when misalignment occurs in one laser in correcting the misalignment of the sub-scanning direction in the image forming apparatus using the multi-beam scanning optical system. In FIGS. 16A to 16F, the same multi-beam ROS as that in FIGS. 15A to 15F is used. However, as shown in FIG. 16F, the example shown in FIGS. 16A to 16F are different from that in FIGS. 15A to 15F in that the laser LD3 of the four lasers is misaligned to lean to the laser LD2. FIGS. 16A to 16E illustrate the output of an image in a case in which the four lasers LD1 to LD4 are shifted to correct the misalignment of the sub-scanning direction. In this case, since the laser LD3 is misaligned with respect to three other lasers LDs, a gap is generated between the lasers LD3 and LD4. The position of this gap with respect to the image shown in each of FIGS. 16A to 16E is changed (moved) on the drawn image by the shift of the lasers LDs. That is, the output direction of striation is misaligned by an image. Therefore, the variation of the gap position appears as the variation of density as shown on the lower side of each of the images in this example. This variation of density is related to the shape and periodicity of an image to be drawn and the scanning period of multi-beams. More specifically, in the four-line periodicity of an image shown in FIG. 16A, four beams of the ROS shown in FIG. 16F synchronize with each other and have four-line (pixel) periodicity. Thus, a defect in image quality occurs, and density irregularity also occurs. FIGS. 16A to 16F illustrate a defect caused by the density variation generated on the entire surface of a sheet of paper when correcting the misalignment of the sub-scanning direction, which is generated when the image writing position of the sub-scanning direction is varied before and after color registration correction. That is, FIGS. 16A to 16F illustrate the variation of density for each sheet outputted.

FIG. 17 illustrates the variation of density on a sheet when skew correction is performed by stepwise shifting output image data in the main scanning direction. FIG. 17 shows a case in which the skew correction as shown in FIGS. 14A and 14B are performed by the combination of images shown in FIGS. 14A and 14B, under a state in which the misalignment of the laser LD3 occurs. In FIG. 17, the same density variation as that in FIGS. 16A to 16F are periodically (in the order of A→B→C→D→E (A)) generated whenever the shift of skew is performed. Since the density variation at the time of skew correction is a density irregularity varied in the main scanning direction on a sheet, the density variation at the time of skew correction has a greater influence on a defect in image quality than the density variation for each sheet.

### SUMMARY OF THE INVENTION

The present invention is designed to solve the above-mentioned problems, and it is an object of the present invention to prevent a defect in image quality when the correction of the sub-scanning direction or skew correction is performed, for example, in an inkjet-type image forming apparatus having a plurality of printing sources or in an image forming apparatus using a multi-beam scanning optical system.

It is another object of the present invention to perform a preferred image shifting process according to a periodic characteristic of collective scanning and a periodic characteristic of an image.

Therefore, according to the present invention, in order to achieve the above objects, when an optical system of a multi-laser ROS is used, it is determined whether to insert an image additionally using a periodic characteristic of exposure by the multi-laser ROS and a periodic characteristic of image data. That is, an image forming apparatus according to the present invention includes an input unit for inputting image data; a printing unit having a plurality of printing sources and collectively scanning an image carrier with the printing sources and beams from the printing source to print the image carrier; an image shift processing unit for performing an image shift in a sub-scanning direction, which is a moving direction of the image carrier, based on a periodic characteristic of printing by the printing unit and a periodic characteristic of an image when image data input by the input unit is drawn. Scanning by the printing sources may include scanning by nozzles in an inkjet method. In this case, the image carrier corresponds to a sheet of paper. Further, the term ‘printing’ is not limited to forming characters, such as text, but is used for forming various images other than characters in a wide meaning, that is, includes an exposure function in an image forming apparatus adopting an electrophotographic manner, an ink discharging function from a printer head in an image forming apparatus adopting an inkjet manner, etc.

In the image forming apparatus according to present invention, the plurality of printing sources of the printing unit is a plurality of laser beam sources, and the printing unit is an exposure unit using multi-beam that collectively irradiates a plurality of laser beams from the plurality of laser beam sources using a rotary polygon mirror.

Further, in the image forming apparatus according to the present invention, the periodic characteristic of printing used for the image shift processing unit is periodic printing disarrangement caused by the effective number of lines collectively scanned by the printing unit. For example, when adjacent exposure is performed using 32 beams, the effective number of lines collectively scanned is 32. In addition, in a case of double exposure, the effective number of lines is 16.

Furthermore, in the image forming apparatus according to the present invention, the periodic characteristic of printing used for the image shift processing unit is a characteristic caused by the arrangement shape of the plurality of printing sources included in the printing unit. For example, when the plurality of light sources are arranged in a matrix of M by N (where M and N are integral numbers equal to or greater than 1), a periodic characteristic caused by the number of M or N appears in the multi-beam exposure unit.

Moreover, in the image forming apparatus according to the present invention, the periodic characteristic of printing used for the image shift processing unit is a characteristic caused by a physical characteristic of the plurality of printing sources included in the printing unit. For example, when the printing unit is a multi-beam exposure unit, the periodic characteristic caused by the physical characteristic is a period variation of at least one of the exposure position, amount of light, and diameter of a spot caused by an optical system including a light source.

Further, in the image forming apparatus according to the present invention, the image shifting process by the image shift processing unit is an image inserting and/or thinning out process. In this case, it is possible to generate the plural variations of density in the sub-scanning direction. As a result, it is possible to make the periodicity of the main scanning direction inconspicuous.

Furthermore, in the image forming apparatus according to the present invention, the periodic characteristic of the image used for the image shift processing unit is a characteristic caused by the shape and position of a binary image.

Meanwhile, the present invention provides an image forming method used for an image forming apparatus having a plurality of printing sources and collectively scanning an image carrier with the printing sources or beams from the printing sources to print the image carrier. The image forming method includes a step of performing a screen process on input image data; a step of performing skew correction on the image data on which the screen process has been performed; and a step of performing an image shifting process in a sub-scanning direction, which is a moving direction of the image carrier, based on a periodic characteristic of printing by the collective scanning and a screen period by the screen process.

Further, in the image forming method according to the present invention, the image forming apparatus can perform color printing and has a plurality of printing sources each corresponding to a different color. In the screen process, a different screen is selected for each color, and the image shifting process is performed when the screen selected for each color synchronizes with the period of printing performed by the collective scanning.

Furthermore, in the image forming method according to the present invention, when the image shifting process is performed on at least one of a plurality of colors, the image shifting process is also performed on the other colors. In this case, even when synchronization is not made on a specific color, it is possible to prevent the generation of color misalignment by performing the image shifting process.

Moreover, in the image forming method according to the present invention, the skew correction stepwise shifts the output image data in the main scanning direction in which the collective scanning is performed.

According to the present invention having the above-mentioned configuration, it is possible to realize a preferred image shifting process according to a periodic characteristic of collective scanning and a periodic characteristic of an image.

### BRIEF DESCRIPTION OF THE DRAWINGS

These and other objects and advantages of this invention will become more fully apparent from the following detailed description taken with the accompanying drawings in which:

FIG. 1 is a view illustrating an image forming apparatus according to an embodiment of the present invention;

FIG. 2 is a view illustrating an example of a laser device used for an exposure device;

FIG. 3 is a view illustrating an ideal output state of a surface emitting laser device;

FIGS. 4A and 4B are views illustrating defects in a multi-beam ROS;

FIG. 5 is a view illustrating density irregularity when skew correction is performed under a state in which the positions of the laser diodes deviate;

FIGS. 6A and 6B are views illustrating a first example of a defective image quality correcting method according to the present invention;

FIGS. 7A and 7B are views illustrating density irregularity in the first example;

FIGS. 8A and 8B are views illustrating a second example of the defective image quality correcting method according to the present invention;

FIGS. 9A and 9B are views illustrating density irregularity in the second example;

FIG. 10 is a block diagram illustrating a structure of a control unit for performing a defective image quality correcting process;

FIG. 11 is a flow chart illustrating a process performed by the control unit shown in FIG. 10;

FIGS. 12A and 12B are views illustrating a screen requiring a process according to the present invention and a screen not requiring the process, respectively;

FIGS. 13A and 13B are views illustrating an example of a conventional method of correcting the misalignment of the sub-scanning direction in an image forming apparatus using a multi-beam scanning optical system;

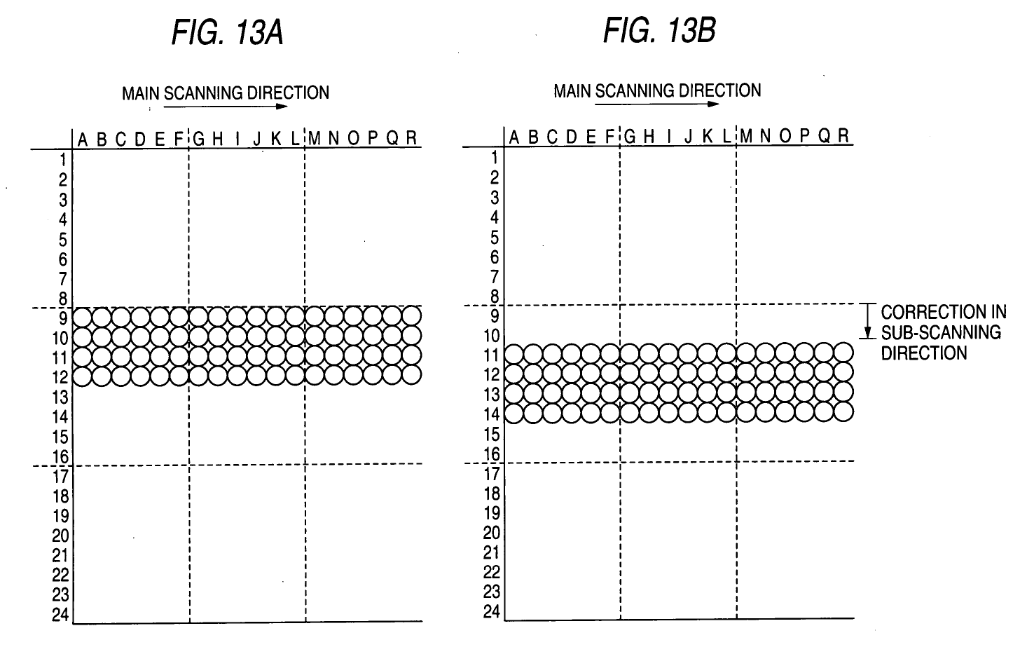

FIGS. 14A and 14B are views illustrating an example of a conventional method of correcting skew in the image forming apparatus using the multi-beam scanning optical system;

FIGS. 15A to 15F are views illustrating an example of the image shift of a half-tone image in correcting the misalignment of the sub-scanning direction in the image forming apparatus using the multi-beam scanning optical system;

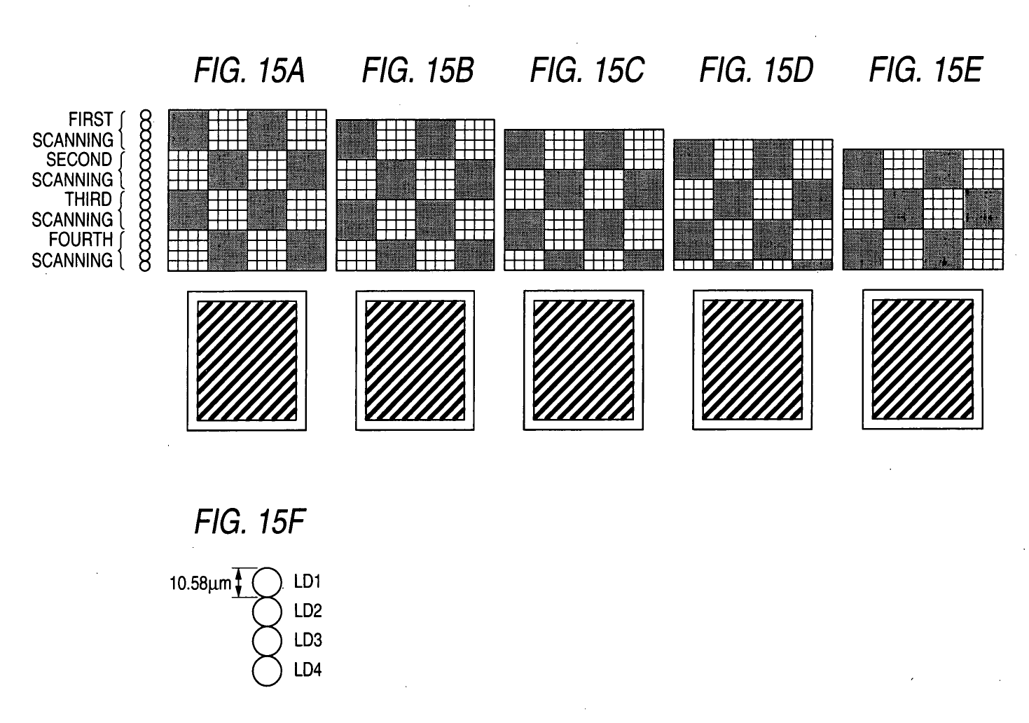

FIGS. 16A to 16F are views illustrating an example of the image shift of the half-tone image when positional deviation occurs in a laser in correcting the misalignment of the sub-scanning direction in the image forming apparatus using the multi-beam scanning optical system; and

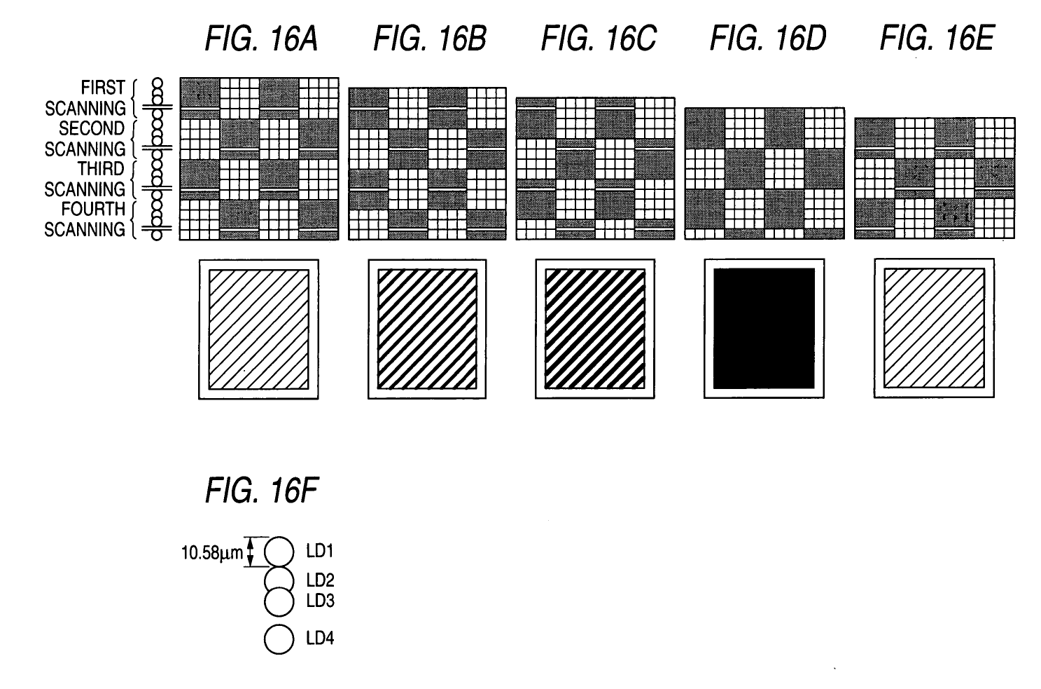

FIG. 17 is a view illustrating the variation of density on a sheet of paper when skew correction is performed by stepwise shifting output image data in the main scanning direction.

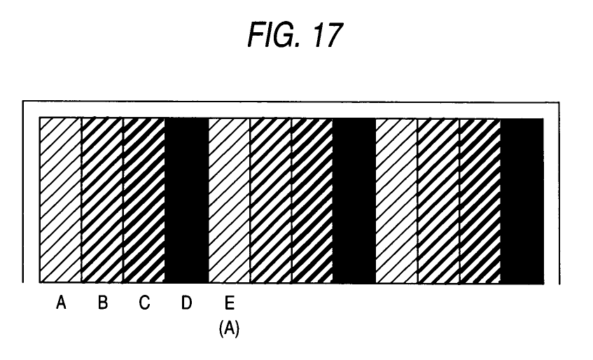

### DETAILED DESCRIPTION OF THE PREFERRED EMBODIMENTS

Hereinafter, preferred embodiments (hereinafter, referred to as embodiments) of the present invention will be described in detail with reference to the accompanying drawings.

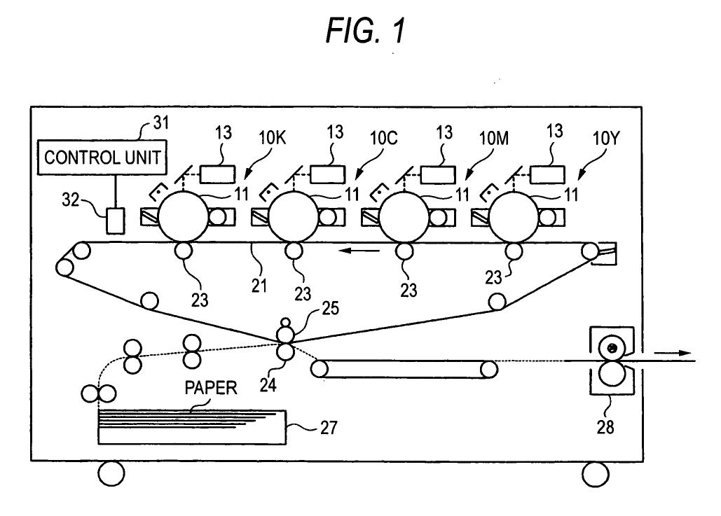

FIG. 1 is a view illustrating an image forming apparatus according to an embodiment of the present invention. The image forming apparatus is a so-called tandem-type digital color electrophotographic method. As shown in FIG. 1, the image forming apparatus includes image forming units 10, exposure devices 13 each of which forms an electrostatic latent image on a photosensitive drum 11 of the image forming unit 10 as a printing function, and a transfer belt 21, serving as an intermediate transfer member, for carrying a toner image carried by the photosensitive drum 11. The image forming units 10 are provided to correspond to yellow (Y), magenta (M), cyan (C), and black (K). Hereinafter, when it is necessary to discriminate these image forming units, the image forming units are referred to as image forming units 10Y, 10M, 10C, and 10K, respectively. However, when it is unnecessary to discriminate these image forming units, the image forming units are simply referred to as an image forming unit 10. In addition, primary transfer rollers 23 for carrying an image on the transfer belt 21 are provided at positions opposite to the photosensitive drums 11 of the respective image forming units 10 on the inner side of the transfer roller 21. Further, secondary transfer rollers 24 are provided at so-called secondary transfer positions where a toner image carried by the transfer belt 21 is transferred onto a sheet of paper, and counter rollers 25 are provided opposite to the secondary transfer rollers 24 on the inner side of the transfer belt 21. Furthermore, the image forming apparatus further includes a sheet feeding cassette 27 for containing sheets, serving as recording media, and a fixer 28 for fixing a transferred sheet. In addition, the image forming apparatus still further includes a control unit 31 for controlling a pixel inserting/thinning out process and an image shift process for correcting color misregistration and a color registration sensor 32 for reading a pattern for controlling color misregistration formed in a predetermined region of the transfer belt 21.

The control unit 31 generates digital image signals of an image obtained by an image reading device (IIT) or image signals of a pattern image used for controlling color misregistration, and supplies them to the exposure device 13 to perform a writing process for the transfer belt 21. The control unit 31 acquires the detection result of the pattern for controlling color misregistration from the color registration sensor 32 and analyzes the amount of color misregistration based on the acquired information to perform a necessary correction process. These functions performed by the control unit 31 are executed by, for example, a CPU (Central Processing Unit) that is program-controlled. In addition, the control unit 31 includes a non-volatile ROM (Read Only Memory) and a read/write RAM (Random Access Memory). This ROM is stored with software programs for controlling an image forming operation, a color misregistration detecting and correcting operation, etc., executed by the control unit and image information of the pattern for controlling color misregistration. The RAM is stored with various information items acquired according to the operation of the image forming apparatus, such as various counter values, the execution number of jobs, and execution information (time information) on the previous color misregistration detecting process.

For example, digital image signals acquired by the image input terminal (IIT) or an external personal computer (PC) and then converted by an image processing device (not shown) are supplied to the exposure devices 13 corresponding to the respective colors through the control unit 31. The color registration sensor 32 is a reflective sensor that forms a pattern (a ladder-shaped toner patch and a chevron patch) for controlling color misregistration formed on the transfer belt 21 on a detector composed of a photo diode (PD) and then detects pulses when a central line of the patch coincides with a central line of the detector. In order to detect the relative color misregistration of the pattern for controlling color misregistration by the patch formed on each image forming unit 10, two color registration sensors 32 are provided along the main scanning direction at, for example, a downstream side of the image forming unit 10K arranged at the lowermost downstream side of FIG. 1. In addition, a light emitting portion of the color registration sensor 32 is provided with, for example, two infrared LEDs (which emits light having a wavelength of 880 nm), so that stabilized pulse output is secured. Therefore, the amount of light emitted from the two LEDs can be adjusted (for example, in two-stage manner).

In each of the four-color image forming units 10Y, 10M, 10C, and 10K, various units for forming an image are provided in the vicinity of the photosensitive drum 11 serving as an image carrier. That is, various devices, such as an electrifying device for electrifying the photosensitive drum 11, a developing device for developing a toner image on the photosensitive drum 11 exposed by the exposure device 13, and a cleaner for removing the remaining toner from the photosensitive drum 11 after the toner image is transferred onto the transfer belt 21, are provided around the photosensitive drum 11. However, it is also possible that a specific color image forming unit corresponding to a specific color other than the general colors Y, M, C, and K, such as a corporate color, which has not been used for forming a general color image is provided as the image forming unit 10. In addition, it is possible to use five or more colors including dark yellow other than the four colors Y, M, C, and K as the general colors. However, in the present embodiment, the axial direction of the photosensitive drum 11 serving as an image carrier is the main scanning direction, and the moving direction by the rotation of the photosensitive drum 11 is a sub-scanning direction.

Here, in the exposure devices 13 for exposing the respective photosensitive drum 11 of the four-color image forming units 10Y, 10M, 10C, and 10K, a multi-beam raster output scanner (ROS) is used, and each exposure device has a plurality of light sources composed of a plurality of laser diodes (LDs). Laser beams irradiated from the plurality of light sources are collimated by a collimating lens and then are scanned by a deflecting reflection surface of a rotary polygon mirror. Then, the photosensitive drum 11 is scanned and exposed by a laser spot concentrated by an image forming lens. The photosensitive drum 11 is rotatably driven by a driving unit and is then exposed in a direction (the sub-scanning direction) orthogonal to the laser scanning direction (the main scanning direction), thereby realizing two-dimensional exposure recording.

As the transfer belt 21, an endless belt formed by shaping a synthetic resin film made of, for example, polyimide having flexibility in a stripe shape and by connecting both ends thereof using a welding unit is used. The transfer belt 21 is formed in a rope shape, and at least a portion of the transfer belt 21 is extended substantially in a straight line by a driving roller and a backup roller. In addition, the four-color image forming units 10Y, 10M, 10C, and 10K and the primary transfer rollers 23 opposite thereto are arranged substantially in the horizontal direction with respect to the substantially straight line portion at predetermined gaps. In the example shown in FIG. 1, the yellow image forming unit 10Y, the magenta image forming unit 10M, the cyan image forming unit 10C, and the black image forming unit 10K are sequentially arranged from the upstream side toward the downstream side of the transfer process in the moving direction of the transfer belt 21. In the transfer belt 21, the respective color images formed by the image forming units 10 sequentially overlap each other by the operation of the belt, thereby forming a color toner image. Further, the color toner image formed on the transfer belt 21 is transferred onto a sheet at a position including the secondary transfer roller 24 and the counter roller 25 at the timing when the movement of the transfer belt 21 corresponds to the carrying of the sheet. Then, the sheet having the color toner image thereon is carried to the fixer 28, and the color toner image is fixed on the sheet by the fixer 28. Subsequently, the sheet is discharged to a discharging tray provided at the outside of a case of the image forming apparatus.

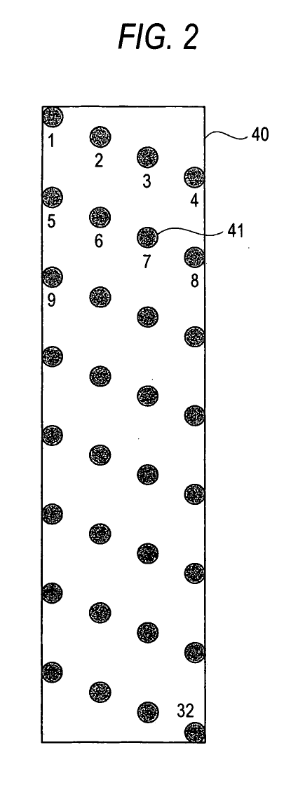

FIG. 2 is a view illustrating an example of a laser device used for the exposure device 13. In the present embodiment, a surface emitting laser device 40 as shown in FIG. 2 is provided in the exposure device 13. The surface emitting laser device 40 is provided with thirty-two laser diodes (LD1 to LD 32) 41 arranged in a matrix of four by eight (arrangement shape) serving as printing sources. Therefore, it is possible to simultaneously scan thirty-two lines by thirty-two laser beams irradiated from the thirty-two laser diodes 41. Since the thirty-two multi-beams are irradiated from one device, the positional relationship between thirty-two laser beams can be maintained to a certain degree of precision. However, the positional deviation in the rotation direction or the deviation of a scanning position can occur by loose mounting of the device or temperature variation.

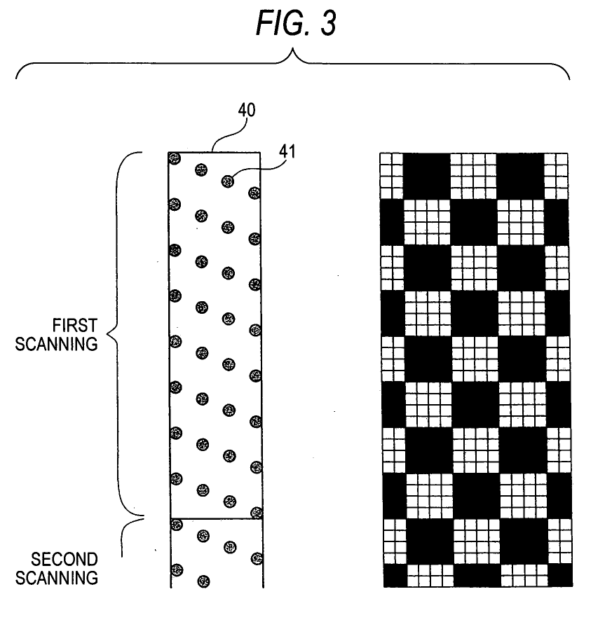

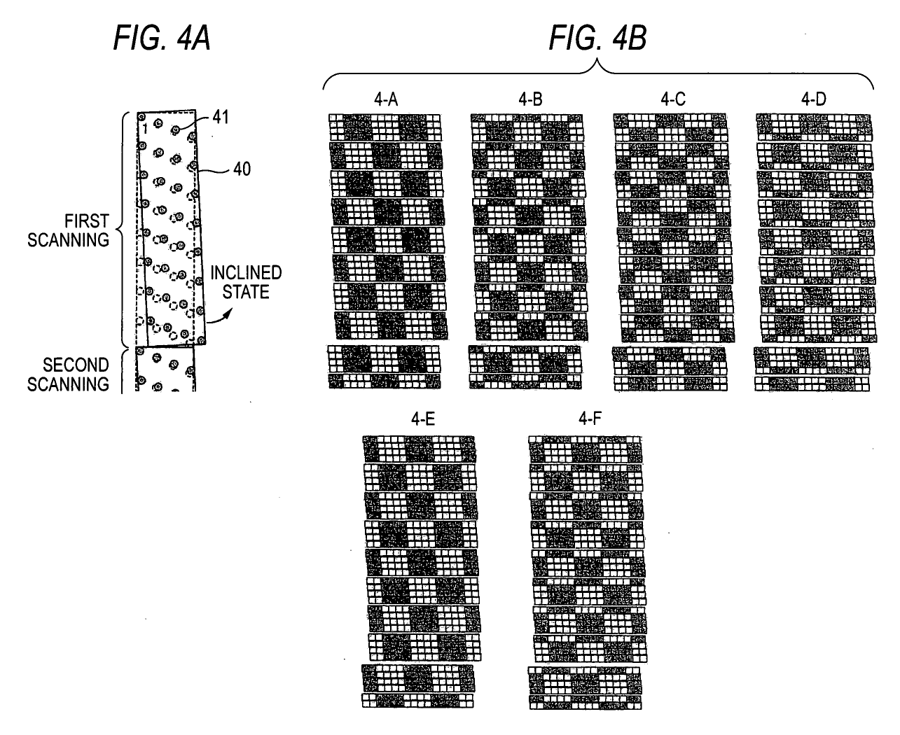

A problem of the scanning position misalignment will be described with reference to FIGS. 3 and 4.

FIG. 3 is a view for explaining an ideal output state of the surface emitting laser device 10. In FIG. 3, exposure is performed in a state in which the surface emitting laser device 40 is not misaligned, and first scanning and second scanning are performed without misalignment, thereby obtaining a clear ladder pattern.

Meanwhile, FIGS. 4A and 4B show defects in the multi-beam ROS. FIG. 4A shows a case in which exposure is performed by the surface emitting laser device 40 at a position inclined from a normal position (the position shown in FIG. 3) represented by a dotted line. As shown in FIG. 4A, when the exposure position of the surface emitting laser device 40 deviates in a counter clockwise direction with the laser diode (LD1) 41 used as a fulcrum, the deviation of the scanning position occurs in the sub-scanning direction as shown in 4-A to 4-F of FIGS. 4A and 4B. In this case, the larger the distance from the LD1 serving as a fulcrum becomes, the greater the positional deviation is. Referring to the numbers of the laser diodes 41 shown in FIG. 2, for example, LD 4 has positional deviation greater than LD 5. Further, when the step of the sub-scanning direction is changed as between LD4 and LD5 or between LD8 and LD9, the gap between the scanning lines is wide. In addition, at the scanning position of LD32, the greatest positional deviation occurs between the sub-scanning direction and the main scanning direction. As a result, the positional deviation between LD32 and LD1 to be subsequently scanned becomes great. FIGS. 4A and 4B shows a small amount of positional deviation with emphasis, but LD32 actually deviates by about several microns. When a laser having a resolution of 2400 dpi is used, the positional deviation of a maximum of 10.6 microns occurs.

In a state in which the positional deviation shown in FIGS. 4A and 4B occurs, when the surface emitting laser device 40 is shifted so as to output an image in the sub-scanning direction, a defect (in this case, gap) in the quality of an image occurs, which results in generating the irregularity of color density.

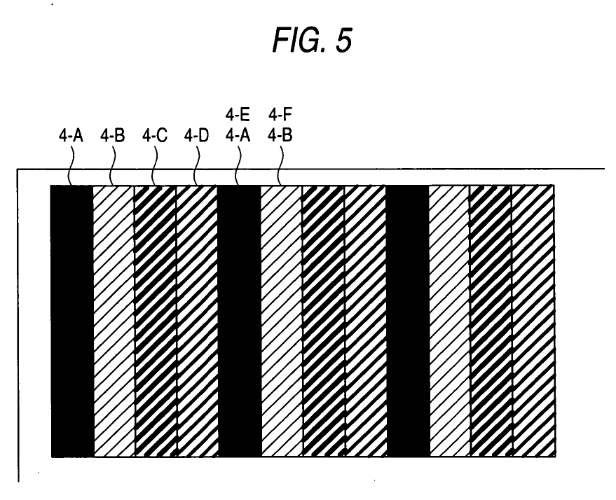

FIG. 5 is a view illustrating the irregularity of color density when skew adjustment is performed under a state the positional deviation of the laser diode 41 occurs as shown in FIGS. 4A and 4B. In the example shown in FIG. 5, the irregularity of color density occurs by deviation of the scanning position of the laser diode 41 and synchronization of the image periods of four pixels. In addition, the same color density periodically exists at a four sub-scanning LD shift period by skew correction.

Further, in the above-mentioned example, the deviation of the scanning position of the laser diode 41 has been described, but the cause of the image quality irregularity is not limited to the deviation of the scanning position. For example, the amount of light emitted from the laser diode 41 (including a defective laser diode 41 emitting no light) or the diameter of a spot has an influence on the irregularity of color density, similarly to the above, which causes a defect in image quality. Here, when the periodicity of a badness in laser diode 41 (LD badness) is completely asynchronous with the period of an image to be drawn, a defect, such as the irregularity of color density, does not occur. Therefore, it is difficult to accurately grasp the periodicity of the LD badness. Accordingly, in the present embodiment, pixels are inserted into predetermined positions corresponding to the original image, and a portion of the original image is shifted in the sub-scanning direction, so that the deterioration of image quality caused by the periodic variation of the exposure position by the multi-beams and by the periodicity of an image to be drawn is reduced.

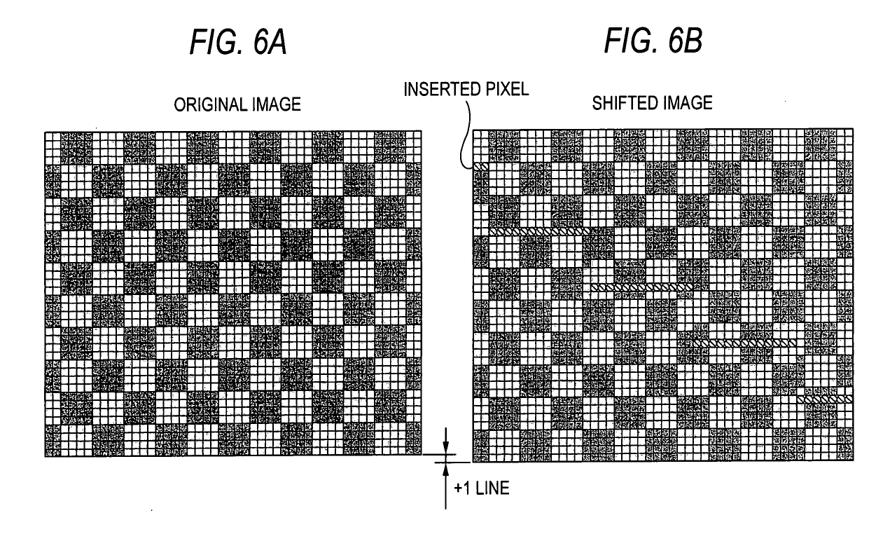

FIGS. 6A and 6B are views illustrating a first embodiment of a bad image quality correcting method according to the present embodiment. FIG. 6A shows an original image, and FIG. 6B shows a shifted image (a corrected image). In the shifted image shown in FIG. 6B, pixels are inserted into predetermined positions corresponding to the original image, and then the image is shifted in the sub-scanning direction. This process causes the relationship between image data and an exposure LD before the insertion is performed to differ from that after the insertion is performed. More specifically, the exposure position shown in FIGS. 4A and 4B varies, and in a case of the output image data shown in FIGS. 4A and 4B, the relationship between the image data and the exposure LD before the pixel insertion is performed turns to the density state shown in 4-A of FIG. 4B. Meanwhile, as shown in FIG. 6B, when a pixel is inserted in every row in the main scanning direction, the image exposed after the pixel is inserted is shifted in the sub-scanning direction by one pixel. As a result, the image having the density shown in 4-A of FIG. 4B turns to the image having the density shown in 4-B by the pixel insertion.

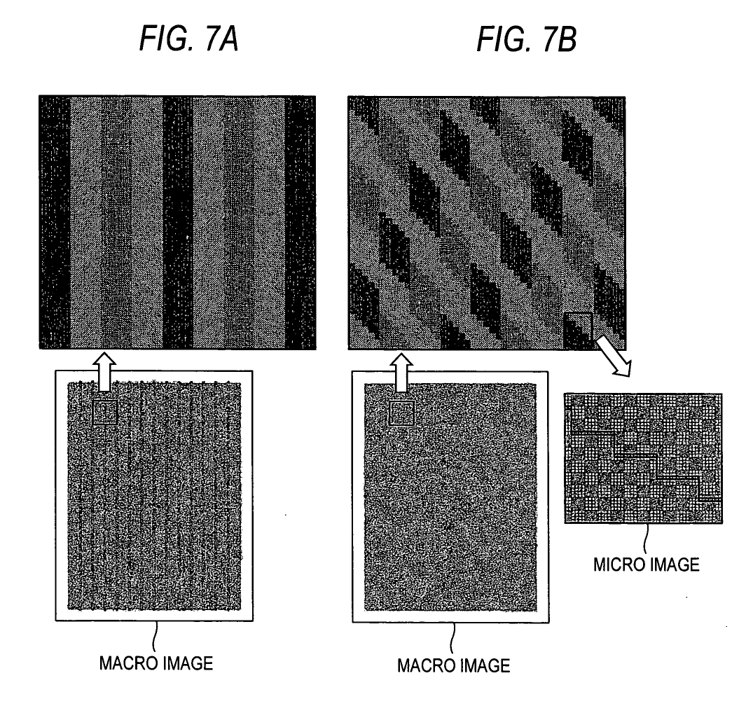

FIGS. 7A and 7B are views for explaining the density irregularity of the first example. FIG. 7A shows a case in which the correction is not performed, and FIG. 7B shows an aspect of density irregularity when pixels are inserted at predetermined gaps. FIGS. 7A and 7B show macro images and density irregularity, respectively. In addition, FIG. 7B also shows a micro image. As shown in FIG. 7A, in the image before correction shown in FIG. 6A, the variation of density extending in the vertical direction is in a vertical stripe, similarly to FIG. 5, and is perceived as density irregularity in the macro image. Meanwhile, when the pixel insertion is performed as in the first example of the present embodiment, the variation of density occurs at a plurality of positions (in this case, four) in the longitudinal direction (the sub-scanning direction) by image shift as shown in FIG. 7B, and periodicity in the lengthwise direction (the main scanning direction) is not perceived. In the example shown in FIG. 7B, when pixel insertion is performed in the longitudinal direction, for example, at 500-pixel intervals at 2400 dpi, the variation of density at 500-pixel intervals occurs. Thus, it is difficult to visually observe density irregularity from a macro point of view.

Further, in the first example, the pixels are inserted in every row. However, when the pixels are inserted in such simple arrangement, the interference between the inserted pixels and the image data characteristics (a screen shape, etc.) may cause a stripe-shaped defect in image quality. In order to make up for the above-mentioned defect, the following second example is effective.

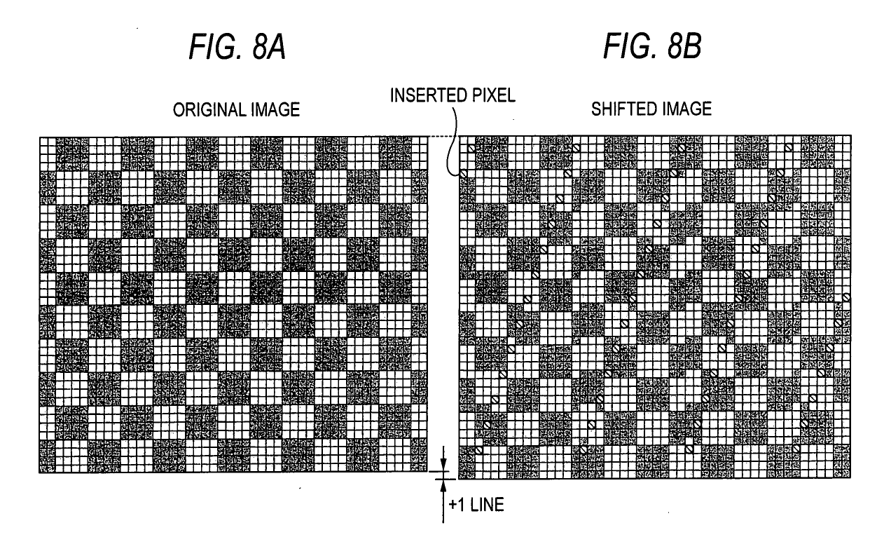

FIGS. 8A and 8B are views illustrating the second example of a bad image quality correcting method according to the present embodiment. FIG. 8A shows the original image, and FIG. 8B shows a shifted image (a corrected image). In the first example shown in FIG. 6B, the pixels are inserted in every row. However, in the second example shown in FIG. 8B, the insertion position deviates from the sub-scanning direction and is set in a straight line at a predetermined angle. In this way, it is possible to prevent the generation of the stripe-shaped defect in image quality caused by the interference between the position of the inserted pixel and the image data characteristics. In addition, the same data as image data on the position of an object to be inserted is inserted as the inserted image data.

Further, various methods of specifying a pixel insertion position are considered. For example, it is considered a method of randomly setting the pixel insertion position in the width of a certain sub-scanning line. In addition, there is a method of setting the position in arrangement having various angles and periodic components by the calculation of functions. Further, there is a method of setting the position to correspond to data of the original image. For example, it is possible to set the pixel insertion position to deviates by an angle of 45°, or it is possible to set to be asynchronous with the period of data of the original image. Further, it is preferable that the pixel data to be inserted be determined such that the density of the original image can be maintained and that be inserted at the same rate as the density of the original image. Furthermore, there is also a method in which the pixel data to be inserted is determined by peripheral pixel data. Moreover, it is effective that the same number of pixels is inserted in every row.

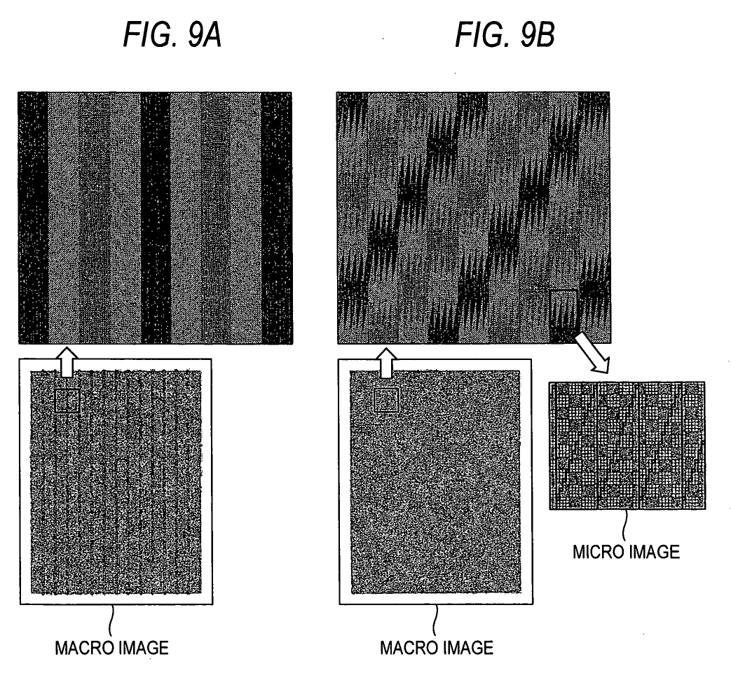

FIGS. 9A and 9B are views for explaining the irregularity of density in the second example. FIG. 9A shows a case in which correction is not performed, and FIG. 9B shows the irregularity of density when an insertion process is performed at a gap. FIGS. 9A and 9B show the macro image and the irregularity of density, respectively. In addition, FIG. 9B also shows a micro image. In the image before correction shown in FIG. 9A, the variation of density extending in the vertical direction is in a vertical stripe, similarly to FIG. 5, and is perceived as density irregularity in the macro image. Meanwhile, when pixel insertion is performed as in the second example of the present embodiment, the variation of density occurs at a plurality of positions (in this case, four) in the longitudinal direction by image shift as shown in FIG. 9B, and periodicity in the lengthwise direction is not perceived. Thus, it is difficult to visually observe density irregularity from a macro point of view.

As described above, in the first and second examples, a portion of the original image is shifted in the sub-scanning direction by inserting pixels into the original image having a defect in quality. That is, phases are changed before and after the pixels are inserted, and the laser diodes 41 used are changed. In this way, the variation of density occurs in the sub-scanning direction as well as the main scanning direction, which makes it possible to reduce the irregularity of density. Meanwhile, the pixel insertion process causes an increase in the number of image data lines in the sub-scanning direction, which results in the variation of magnification in the sub-scanning direction. That is, when an insertion gap is, for example, 500 lines, an image magnification of 0.2%(= 1/500) is made. In this case, such a degree of magnification does not matter in the image used for general business. However, in a case of images used for the commercial purpose, such a degree of magnification may raise a problem. Therefore, it is preferable that the number of pixels to be inserted be as small as possible. In addition, in order to prevent the expansion of the width of an image in the sub-scanning direction by the pixel insertion process, it is possible to perform a thinning out process. For example, preferably, the insertion process and the thinning out process are alternately performed by the same number of times such that the insertion process is performed on the first 500 lines and then the thinning out process is performed on the next 500 lines. In this case, the pattern of density variation is halved. In addition, the insertion process and the thinning out process may be performed, for example, at a ratio of 2 to 1.

Next, a structure for realizing the bad image quality correcting method will be described.

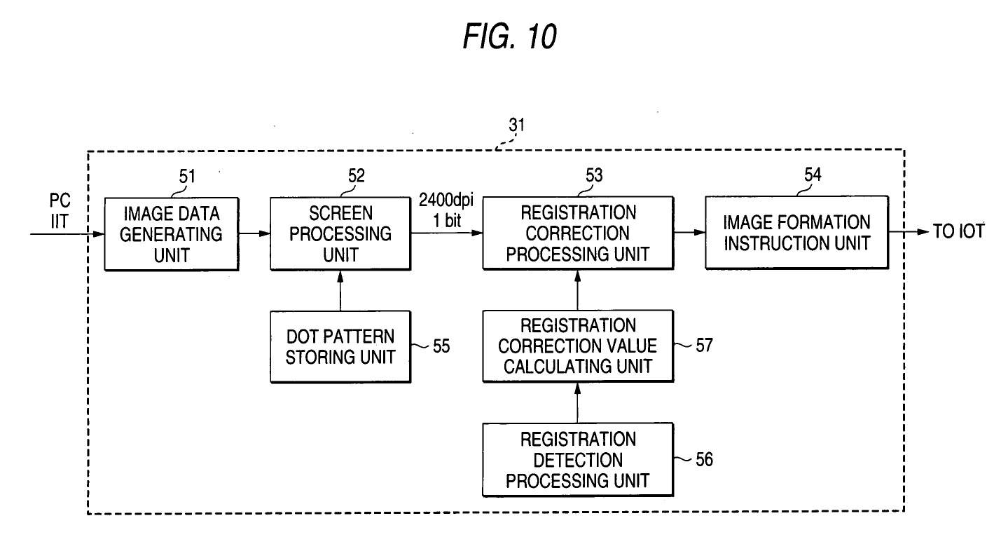

FIG. 10 is a block diagram illustrating a structure of a control unit 31 for executing the above-mentioned bad image quality correcting process. The control unit 31 includes, for example, an image data generating unit 51 for converting an input image into image data peculiar to the image forming apparatus, a screen processing unit 52 for performing a screen process on the image output from the image data generating unit 51, and a registration correction processing unit 53 for performing various processes, such as skew correction, magnification process, and correction for the screen. In addition, the control unit 31 further includes an image formation instructing unit 54 for outputting image information to the ROSs (an ROS for Y, an ROS for M, an ROS for C, and an ROS for K) of the exposure device 13 corresponding to the image forming units 10Y, 10M, 10C, and 10K for forming images having respective colors Y, M, C, and K. Further, the control unit 31 still further includes a dot pattern storing unit 55 stored with dot pattern information on the respective colors Y, M, C, and K or on every object. Furthermore, the control unit 31 yet further includes a registration detection processing unit 56 for detecting the skew or misalignment of each color with respect to, for example, black, which is a reference color, in the sub-scanning direction using, for example, the color misalignment sensor 32 and a registration correction value calculating unit 57 for calculating a registration correction value when an image address in a header is changed and output.

The image data generating unit 51 converts the image data output from a personal computer or IIT, such as a page describing language or bitmap data, into image data peculiar to the image forming apparatus. The image data generated by the image data generating unit 51 may be represented by 600 dpi (8 bits)+Tag (4 bits) by multi-valued data or may be represented by 600 dpi (1 bit) or 1200 dpi (1 bit) by binary data. The screen processing unit 52 respectively performs a suitable process on a specific color and a specific object (for example, photographs and characters are separately processed), and then outputs, for example, image data of 2400 dpi (1 bit). In the screen processing unit 52, a text/image separating (T/I separating) process is performed, and a dot pattern is read from the dot pattern storing unit 55. The registration detection processing unit 56 grasps periodic characteristics of exposure of the ROSs (the ROS for Y, the ROS for M, the ROS for C, and the ROS for K) of the exposure devices 13 corresponding to the respective image forming units 10Y, 10M, 10C, and 10K and then stores them therein. The registration correction value calculating unit 57 calculates the insertion positions of the pixels or the deviation amount of image output timing for every line for the bad image quality correcting method. The registration correction processing unit 53 performs the insertion process of the pixels or the deviation process of image output timing for every line for the bad image quality correcting method, using the registration correction value calculated by the registration correction value calculating unit 57. Further, the image data generating unit 51 is provided in the control unit of the image forming apparatus, but may be arranged in an external control unit provided in other apparatuses other than the image forming apparatus.

Next, a process executed by the control unit 31 will be described.

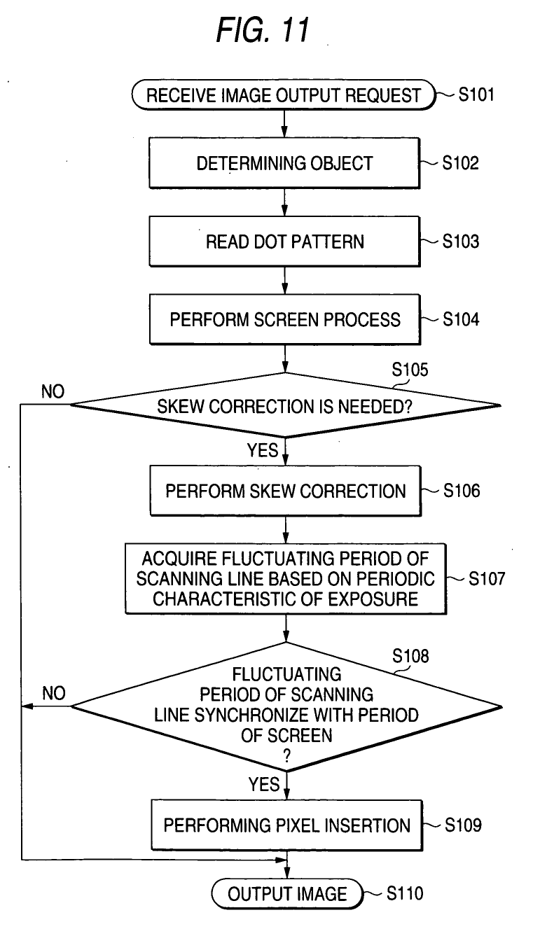

FIG. 11 is a flow chart illustrating the process executed by the control unit 31 shown in FIG. 10. When an image output request is received (step 101), the screen processing unit 52 of the control unit 31 performs object determination, such as the recognition of a text or image, on the image data output from the image data generating unit 51 (step 102). In the screen processing unit 52, a predetermined dot pattern is read from the dot pattern storing unit 55 (step 103), based on the color of the image data and the object determination, and a screen process is then performed (step 104).

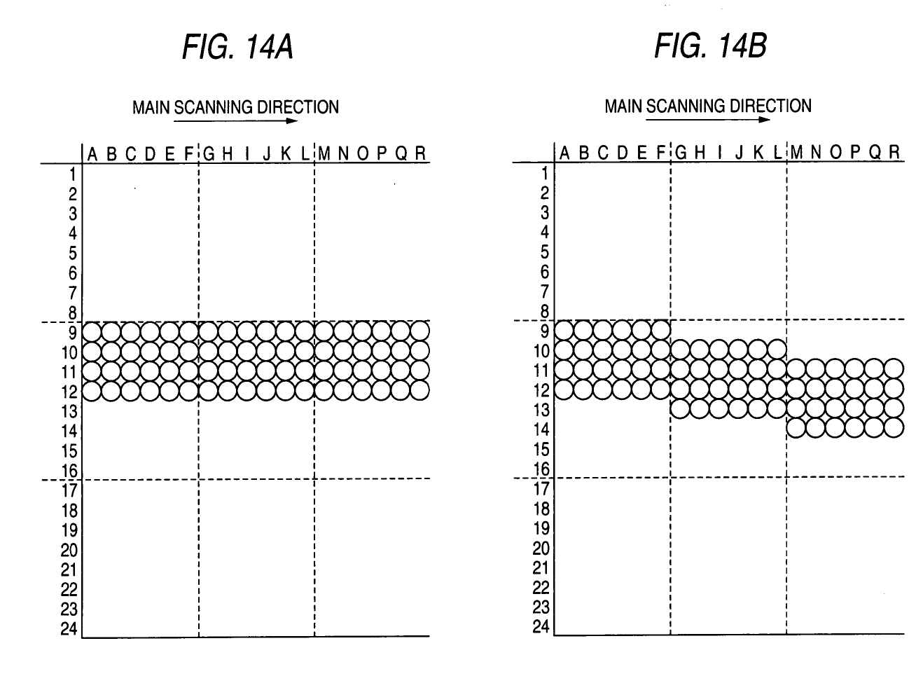

The registration correction processing unit 53 determines whether skew correction should be performed or not (step 105). Whether the skew correction should be performed or not is determined, for example, based on the detection result of a pattern for controlling color misalignment acquired by the color misalignment sensor 32. For example, the skew correction may be performed at the time of color registration. More specifically, color registration may be performed by executing the skew correction on other colors on the basis of one color, such as black (K). When it is determined that it is not necessary to perform the skew correction in step 105, the process proceeds to step 110. On the other hand, when it is determined that it is necessary to perform the skew correction in step 105, for example, a skew correction process shown in FIG. 14B is performed (step 106).

Thereafter, in the registration correction processing unit 53, the fluctuation period of the scanning line is acquired based on the periodic characteristic of exposure (step 107). When the surface emitting laser device 40 shown in FIG. 2 is used, the periodic characteristic of exposure may be caused by the deviation the physical position of each laser diode 41. In addition, as shown in FIG. 4A, the cause may also be the positional deviation of the surface emitting laser device 40. Further, the cause may be a variation in exposure amount caused by a difference in reflectance between light components emitted from the respective laser diodes 41 in their optical paths. The registration correction processing unit 53 determines whether the periodic characteristic of exposure (scanning line) generated by these causes is synchronous with the period of the screen determined by the screen processing unit 52 (step 108). When they are asynchronous with each other, the process proceeds to step 110. When they are synchronous with each other, the pixel insertion process is performed as shown in FIGS. 6B and 8B (step 109). In this pixel insertion process, if necessary, the pixel thinning out process can be jointly performed. After the pixel insertion process is completed in this way, image data is output from the image formation instructing unit 54 to an IOT (Image Output Terminal) (step 110).

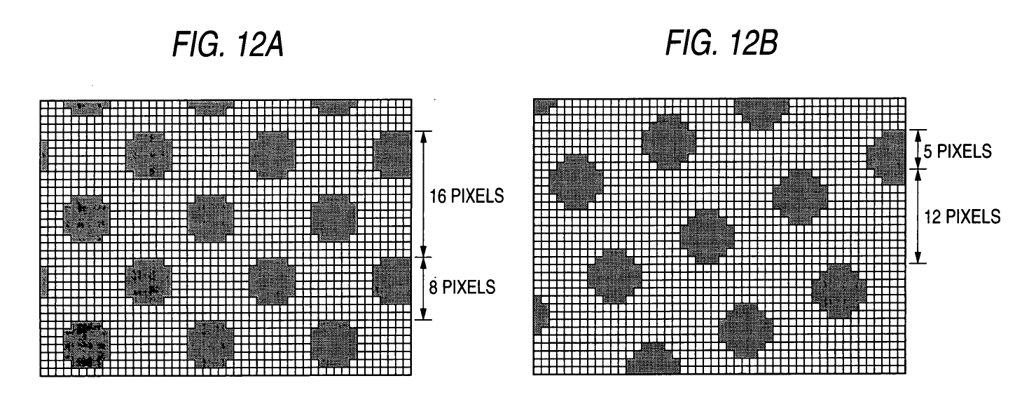

As such, according to the present embodiment, in the multi-beams emitted from, for example, the surface emitting laser device 40 shown in FIG. 2, it is possible to correct a periodic defect in image quality generated by the synchronization between the periodicity of characteristics of the respective laser diodes (LD) 41 and the alignment period of image data. When they are asynchronous with each other, the problem of the periodic defect in image quality does not arise. However, for example, when the periodicity of a multi-beam characteristic is 4 and the image data has a periodicity of 4, a defect in image quality easily occurs. An example in which the image data has the periodicity of 4 includes a case in which resolution is converted from binary data of 600 dpi to a binary image of 2400 dpi. In addition, for example, the screen of 212 lpi (line per inch) as shown in FIG. 12A has the periodicity of 8 pixels or 16 pixels in the sub-scanning direction. Further, in the surface emitting laser device 40 shown in FIG. 2, the position of exposure is changed due to the periodicity of 4 in the arrangement of the laser diodes (LDs) 41. However, in a case of the periodicity of 32 lines formed by one scanning, or in a case in which double exposure is preformed with the 16 lines overlapped, period of the 16 lines may be a problem.

Meanwhile, FIG. 12B shows a screen not requiring the process according to the present embodiment. A screen of 185 lpi shown in FIG. 12B has periodic characteristics of 5 pixels and 12 pixels in the sub-scanning direction. However, in the periodic characteristics, the positions of dots are asynchronous with the periodicity of 4 of the multi-beam, and thus the above-mentioned defect does not occur. That is, odd numbers and even numbers are present, and different laser diodes (LDs) 41 are used corresponding to pixel positions. Therefore, it is not necessary to perform the process according to the present embodiment to such a screen. In step 108 shown in FIG. 11, in a case of such an image, the pixel insertion process is omitted, and the process proceeds to step 110. That is, in order to prevent the unnecessary process in the present embodiment, whether to perform the pixel insertion process may be determined according to image data. For example, determination may be made such that the pixel insertion process is performed for a binary image of 600 dpi or the screen shown in FIG. 12A, and such that the pixel insertion process is not performed for the screen shown in FIG. 12B. As described above, the screen is selected corresponding to an object. Therefore, for example, when tag data is added to every object, it is possible to perform the process corresponding to the screen of multi-valued data, using the tag data corresponding to the object. In addition, different processes can be performed according to whether multi-valued data is used or binary data is used or whether binary data of 600 dpi is used or not.

Further, as shown in the flow chart of FIG. 11, a precondition of the bad image quality correcting method according to the present embodiment is to perform the skew correction shown in step 106. For example, as the bad image quality correcting method performed according to whether the skew correction is executed, the following method can be used: the screen having the periodicity of 4 is set to a specific color, such as black (K); it is confirmed whether to perform the skew correction of black (K), and then the process according to the present embodiment is performed. In addition, another method can be used in which the skew correction is not performed on black (K), which is the reference of the skew correction, but performed on other colors, and then the process according to the present embodiment is performed. Further, it is preferable to avoid performing the skew correction on black (K) as far as circumstances permit.

Furthermore, when the bad image quality correcting method according to the present embodiment is performed on only one specific color, for example, when the pixel insertion process is performed on only black (K) at 500 intervals, a black (K) image is enlarged in the sub-scanning direction by 0.2%. In addition, when the pixel insertion process is not performed on three other colors since it is determined that the process is not needed, the magnification deviation between K and three colors (color registration deviation in which head portions coincide with each other, but the farther it is close to the tail of an image, the larger the deviation is) occurs in the sub-scanning direction. In order to prevent the magnification deviation, the pixel insertion process is performed on one of four colors Y, M, C, and K. Then, even when it is considered that the pixel insertion process is unnecessary for improving the image defect, it is preferable to perform the pixel insertion process for preventing color misalignment. In this case, it is effective to set the positions of pixels to be inserted to correspond to the screen shapes of the respective colors.

Further, the above-mentioned skew correction is to correct the inclination deviation of straight lines extending to the entire width of an image in the main scanning direction. However, the present embodiment can be applied to another process of outputting an image having a local step difference. That is, the present embodiment can be applied to correct the misalignment of a non-linear image, that is, to correct the curvature (a so-called bow) of an image by changing a step difference in the main scanning direction or by changing the direction of the step difference.

As described above, according to the present embodiment, it is possible to reduce defects in image quality caused by the periodic variation of exposure position by the multi-beam and caused by the periodicity of image data to be drawn, by correcting defects in image quality in a manner such as inserting a pixel into a predetermined pixel location corresponding to the original image and by shifting it in the sub-scanning direction. Further, the present embodiment can also be used to adjust the position of an image. For example, the present embodiment can be used to effectively correct a defect in monochromatic image quality generated when selectively switching the laser diodes (LDs) 41 used for outputting an image in the multi-beam, such as the surface emitting laser device 40. As such, the process according to the present embodiment can be applied to a black-and-white image forming apparatus in addition to the color image forming apparatus.

Furthermore, in the above-mentioned examples, the pixel insertion process shown in step 109 of FIG. 11 is used as the image shifting process in the sub-scanning direction. However, it is possible to generate the variation of density in the sub-scanning direction and to make periodicity in the main scanning direction inconspicuous by performing the pixel thinning out process, instead of the pixel insertion process.

Moreover, in the present embodiment, the image forming apparatus adopting an electrophotographic method has been described. However, the bad image quality correcting method according to the present embodiment can also be applied to an image forming apparatus adopting an inkjet method. When a plurality of nozzles, which is printing sources, is provided instead of the scanning of the multi-beam, an image shift process is performed in the sub-scanning direction, which is the moving direction of an image carrier (for example, a sheet of paper), by a printing unit for printing an image on the image carrier (for example, a sheet of paper) by the collective scanning of the plurality of nozzles. In this way, it is possible to obtain the same effects as those in the electrophotographic method. However, when the present embodiment is applied to an electrophotographic method using the multi-beam ROS, it is possible to obtain remarkable effects, which is not obtained by the inkjet method. For example, it is possible to correct periodic characteristics caused by the difference of a reflective index in an optical path or the difference between the contact positions of a rotary polygon mirror in the respective LDs. In addition, for example, even when the characteristics of the plurality of LDs are separately changed by the temperature variation and even when refractive indexes are different from each other by a difference in wavelength, it is possible to perform correction. In this way, when the present embodiment is applied to the image forming apparatus using the multi-beam ROS, it is possible to obtain greater effects.

What is claimed is:

1. An image forming apparatus comprising:
an input unit for inputting an image data;
a printing unit having a plurality of printing sources and collectively scanning an image carrier with the printing sources or beams from the printing source to print the image carrier; and
an image shift processing unit for performing an image shift in a sub-scanning direction, which is a moving direction of the image carrier, based on a periodic characteristic of printing by the printing unit and a periodic characteristic of an image when the image data input by the input unit is drawn.

2. The image forming apparatus according to claim 1, wherein:
the plurality of printing sources of the printing unit is a plurality of laser beam sources; and
the printing unit is an exposure unit using multi-beams that collectively irradiates a plurality of laser beams from the plurality of laser beam sources using a rotary polygon mirror.

3. The image forming apparatus according to claim 1, wherein
the periodic characteristic of printing used for the image shift processing unit is a periodic printing disarrangement caused by the effective number of lines collectively scanned by the printing unit.

4. The image forming apparatus according to claim 1, wherein
the periodic characteristic of printing used for the image shift processing unit is a characteristic caused by an arrangement shape of the plurality of printing sources included in the printing unit.

5. The image forming apparatus according to claim 1, wherein
the periodic characteristic of printing used for the image shift processing unit is caused by a physical characteristic of the plurality of printing sources included in the printing unit.

6. The image forming apparatus according to claim 5, wherein
when the printing unit is a multi-beam exposure unit, the periodic characteristic caused by the physical characteristic is a period variation of at least one of the exposure position, amount of a light, and a diameter of a spot caused by an optical system including a light source.

7. The image forming apparatus according to claim 1, wherein
the image shifting process by the image shift processing unit is at least one of an image inserting or a thinning out process.

8. The image forming apparatus according to claim 1, wherein
the periodic characteristic of the image used for the image shift processing unit is a characteristic caused by the shape and position of a binary image.

9. An image forming method used for an image forming apparatus having a plurality of printing sources and collectively scanning an image carrier with the printing sources or beams from the printing sources to print the image carrier, the image forming method comprising:
performing a screen process on an input image data;
performing a skew correction on the image data on which the screen process has been performed; and
performing an image shifting process in a sub-scanning direction, which is a moving direction of the image carrier, based on a periodic characteristic of printing by the collective scanning and a screen period by the screen process.

10. The image forming method according to claim 9, wherein:
the image forming apparatus can perform a color printing and has a plurality of printing sources each corresponding to a different color;
in the screen process, a different screen is selected for each color; and
the image shifting process is performed when the screen selected for each color synchronizes with the period of printing performed by the collective scanning.

11. The image forming method according to claim 10, wherein
when the image shifting process is performed on at least one of a plurality of colors, the image shifting process is also performed on the other colors.

12. The image forming method according to claim 9, wherein
the skew correction shifts the output image data stepwise in the main scanning direction in which the collective scanning is performed.
